(19) United States
(12) Patent Application Publication
(10) Pub. No.: US 2010/0149470 A1
(43) Pub. Date: Jun. 17, 2010

(54) PRECURSOR FILM FOR RETARDATION FILMS, RETARDATION FILM, AND LIQUID CRYSTAL DISPLAY DEVICE

(76) Inventors: Kyoko Hino, Sodegaura-shi (JP); Toshihiko Suzuki, Ichihara-shi (JP); Hiroaki Takahata, Ichihara-shi (JP); Takashi Sakurai, Sodegaura-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/593,537

(22) PCT Filed: Sep. 25, 2007
(86) PCT No.: PCT/JP2007/069152

§ 371 Date: Feb. 3, 2010

(30) Foreign Application Priority Data
Mar. 30, 2007 (JP) 2007-091205

(51) Int. Cl. G02F 1/13363; G02B 1/08

(52) U.S. Cl. 349/117; 359/500; 428/1.3

(57) ABSTRACT

Provided is a film that is made of a propylene-based copolymer selected from among propylene-based random copolymers and propylene-based block copolymers, the film being useful as a precursor film for the production of a retardation film by stretching. The propylene-based copolymer forming the film contains crystals containing smectic crystals, wherein the percentage of smectic crystals to all the crystals of the propylene-based copolymer. The film has an in-plane retardation of 50 nm or less and a thickness falling within the range of 30 to 200 μm. The propylene-based copolymer is a copolymer that has a parameter (A) falling within the range of from 0.0007 to 0.1, the parameter (A) being calculated from Formula (1) defined for a stress-strain curve produced as a result of stretching a film made of the polymer at a tensile rate of 100 mm/minute at a temperature at which a stress of 0.8±0.1 MPa is produced at a strain of 200%:

(A)=(B₆₀₀−B₂₀₀)/400 Formula (1)

wherein B₆₀₀ and B₂₀₀ represent a stress (MPa) at a strain of 600% and a stress (MPa) at a strain of 200%, respectively.

### TECHNICAL FIELD

The present invention relates to a polypropylene resin film useful as a precursor of a retardation film and also to a retardation film produced from said film, and a liquid crystal display device which contains the retardation film as an element.

### BACKGROUND ART

Liquid crystal display devices display images by using electro-optic properties which liquid crystal molecules have. However, since liquid crystals inherently have optical anisotropy, liquid crystal display devices may suffer from, for example, optical distortion caused by birefringent property, and unexpected coloring of display caused by tone change depending upon the viewing direction. In order to eliminate such defects, retardation films have heretofore been used. As a retardation film is known a retardation film obtained by stretching a precursor film made of a polycarbonate resin or a cyclic olefin-based polymer. However, since these resins are expensive, development of retardation films made of more inexpensive plastic materials has been requested.

A retardation film made of a polypropylene resin has already been proposed as a retardation film made of an inexpensive plastic material. However, a polypropylene resin is usually oriented very strongly as a result of film formation by extrusion or subsequently stretching. Therefore, a film of the resin usually exhibits a large retardation and it is difficult to use the film as a retardation film.

As a method for producing a retardation film made of a polypropylene resin, a method has been proposed in which when a polypropylene resin is shaped into a film form with a T-die molding machine, a molten film extruded through a T-die is longitudinally stretched along the flow direction at a low stretching ratio (JP 60-24502 A). According to this method, it is certainly possible to obtain a polypropylene resin film that can partly exhibit a retardation high enough for being used as a retardation film. However, the above-mentioned method will cause unevenness in orientation along the width direction of a film obtained, resulting in generation of unevenness in retardation or, in some cases, generation of unevenness in thickness along the width direction. Therefore, stable production of a film that can be used practically as a retardation film has not been realized, yet.

Moreover, since many polypropylene resins are crystalline plastic materials, it is feared that retardation films made of polypropylene resins will come to have reduced transparency due to the scatter of light caused by resin crystals and, as a result, the films will provide adverse effects, such as decrease in front contrast, on the optical properties of liquid crystal display devices.

### DISCLOSURE OF THE INVENTION

In such situations, the present inventors have researched methods for producing retardation films of polypropylene resin that are uniform in thickness, high in transparency, and less in retardation unevenness. Although polypropylene resins are generally materials that are difficult to stretch uniformly at a low draw ratio, the inventors have accomplished the present invention by finding out that the aforementioned problem can be solved by processing a polypropylene resin that shows special stretch behavior and stretching the resulting film in which a crystal form is controlled.

That is, the present invention is a film comprising a propylene-based copolymer selected from among propylene-based random copolymers and propylene-based block copolymers, wherein the propylene-based copolymer forming the film comprises crystals containing smectic crystals and the percentage of the smectic crystals to all the crystals of the propylene-based copolymer is 90% or more,

wherein the film has an in-plane retardation of 50 nm or less and a thickness falling within the range of from 30 to 200 μm, and the propylene-based copolymer is a polymer that has a parameter (A) falling within the range of from 0.0007 to 0.1, the parameter (A) being calculated from Formula (1) defined for a stress-strain curve produced as a result of stretching a film made of the polymer at a tensile rate of 100 mm/minute at a temperature at which a stress of 0.8±0.1 MPa is produced at a strain of 200%:

(A)=(B₆₀₀−B₂₀₀)/400 Formula (1)

wherein B₆₀₀ and B₂₀₀ represent a stress (MPa) at a strain of 600% and a stress (MPa) at a strain of 200%, respectively.

Retardation films obtained by stretching films of the present invention are free from unevenness derived from optical nonuniformity and are excellent in an effect of improving the viewing angle dependency even when they are used in large-screen liquid crystal display devices, such as a large-screen liquid crystal television. Moreover, a retardation film obtained by stretching a film of the present invention exhibits a low internal haze and, therefore, a liquid crystal display device in which the retardation film is applied is excellent in front contrast.

### BRIEF DESCRIPTION OF THE DRAWINGS

FIG. 1 is a schematic diagram of a sample for a tensile test. In the diagram, sign 1 represents a film and sign 2 represents a line drawn on the film.

FIG. 2 is a diagram illustrating a method of analyzing a wide angle X-ray diffraction profile. In the diagram, sign 3 represents a peak width D (degree) at a level of C×0.8.

### MODE FOR CARRYING OUT THE INVENTION

The film of the present invention is made of a propylene-based copolymer that has a parameter (A) of from 0.0007 to 0.1 as determined by a preliminary test described below, and such a propylene-based copolymer includes at least one polymer selected from among propylene-based random copolymers and propylene-based block copolymers.

### [Preliminary Test]

From a film made of a polypropylene resin is taken a sample of 70 mm and 60 mm in the longitudinal direction of the film and in the lateral direction of the same, respectively. The MD of the film is the longitudinal direction, and the direction perpendicular to the longitudinal direction on the plane of the film is the lateral direction. In accordance with JIS K-7163, a tensile testing machine equipped with a thermostatic oven is used. The sample is held with chucks at its both longitudinal ends so that the distance between the chucks will become 30 mm. Then, the sample is stretched in the longitudinal direction of the film, at a temperature at which the stress at a strain of 200% becomes 0.8±0.1 MPa, at a tensile rate of 100 mm/min until the strain becomes 600%. In the stress-strain curve (so-called S-S curve) obtained by this method, parameter (A) is calculated by Formula (1):

Parameter (A)=(B₆₀₀−B₂₀₀)/400 Formula (1)

wherein B₆₀₀ and B₂₀₀ represent a stress (MPa) at a strain of 600% and a stress (MPa) at a strain of 200%, respectively.

The stretching temperature used in the above-mentioned preliminary test is determined by the following method. First, a tensile test of a film is performed at a temperature near the melting point of the polypropylene resin which forms the film, at a tensile rate of 100 mm/min. The same tensile test is repeated at different temperatures and a temperature at which the stress produced at a strain of 200% becomes 0.8±0.1 MPa is defined as a stretching temperature in the preliminary test. The strain is a ratio of the length increase due to stretching of a stretched portion of the sample to the length of the stretched portion before the stretching.

Examples of the propylene-based random copolymers and the propylene-based block copolymers include copolymers obtained by copolymerizing propylene and one or more α-olefins selected from the group consisting of ethylene and α-olefins having 4 to 20 carbon atoms. The propylene-based copolymer in the present invention is preferably a propylene-based random copolymer.

Examples of the α-olefins having 4 to 20 carbon atoms include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 1-octene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decease, 1-undecene, 1-dodecene, 1-tridecene, 1-tetradecene, 1-pentadecene, 1-hexadecene, 1-heptadecene, 1-octadecene and 1-nonadecene. α-Olefins having 4 to 12 carbon atoms are preferable, 1-butene, 1-pentene, 1-hexene and 1-octene are more preferable, and 1-butene and 1-hexene are even more preferable.

Examples of the propylene-based random copolymers include propylene-ethylene random copolymers, propylene-α-olefin (C4-20) random copolymers and propylene-ethylene-α-olefin (C4-20) random copolymers. More specifically, examples of the propylene-α-olefin (C4-20) random copolymers include propylene-1-butene random copolymers, propylene-1-hexene random copolymers and propylene-1-octene random copolymers, and examples of the propylene-ethylene-α-olefin (C4-20) random copolymers include random copolymers, propylene-ethylene-1-hexene random copolymers and propylene-ethylene-1-octene random copolymers. Preferred are propylene-ethylene random copolymers, propylene-1-butene random copolymers propylene-1-hexene random copolymers, propylene-ethylene-1-butene random copolymers and propylene-ethylene-1-hexene random copolymers.

The content of the constituent units derived from comonomers (i.e., monomers other than propylene) in the propylene-based random copolymers and the propylene-based block copolymers is preferably 1% by weight or more and not more than 40% by weight, more preferably 1% by weight or more and not more than 20% by weight, and even more preferably 1% by weight or more and not more than 10% by weight, from the viewpoint of balance between the transparency and the heat resistance of a film. When the polypropylene resin is a copolymer of propylene and two or more comonomers, it is desirable that the total content of all the constituent units derived from the comonomers contained in the copolymer be within the aforesaid ranges.

Although the method for producing the propylene-based copolymer in the present invention is not particularly restricted, copolymers made up of propylene and one or more α-olefins selected from the group consisting of ethylene and α-olefins having 4 to 20 carbon atoms, for example, can be produced by copolymerizing propylene and a prescribed comonomers using a catalyst for olefin polymerization. Examples of polymerization catalysts that can be applied include

(1) Ti—Mg-based catalysts composed of a solid catalyst component containing magnesium, titanium, and halogen as essential ingredients, etc.,
(2) catalyst systems produced by combining a solid catalyst component containing magnesium, titanium and halogen as essential ingredients with an organoaluminum compound and, if necessary, a third component, such as an electron-donating compound, and
(3) metallocene-based catalysts.

Among these, the catalyst systems in which a solid catalyst component containing magnesium, titanium and halogen as essential ingredients is combined with an organoaluminum compound and an electron donating compound can be used most commonly. More specifically, preferable examples of the organoaluminum compound include triethylaluminum, triisobutylaluminum, a mixture and triethylaluminum and diethylaluminum chloride, and tetraethyldialumoxane, and preferable examples of the electron donating compound include cyclohexylethyldimethoxysilane, tert-butyl-n-propyldimethoxysilane, tert-butylethyldimethoxysilane, and dicyclopentyldimethoxysilane. Examples of the solid catalyst component containing magnesium, titanium and halogen as essential ingredients include the catalyst system disclosed in the JP 61-218606 A. JP 61-287904 A, and JP 7-216017 A. Examples of the metallocene catalysts include the catalyst systems disclosed in Japanese Patent Nos. 2587251, 2627669 and 2668732.

Examples of the polymerization method for the preparation of the propylene-based copolymer include a solvent polymerization process in which an inert solvent is used, the solvent being represented by hydrocarbon compounds such as hexane, heptane, octane, decane, cyclohexane, methylcyclohexane, benzene, toluene and xylene, a bulk polymerization process in which a liquefied monomer is used as both a reactant and a solvent, and a gas phase polymerization process in which a gaseous monomer is polymerized. The bulk polymerization process and the gas phase polymerization process are preferable. Such polymerization methods may be either in a batch mode or a continuous mode. The stereoregularity of the propylene-based copolymer may be in any of isotactic form, syndiotactic form, and atactic form. From the viewpoint of heat resistance, the propylene-based copolymer to be used in the present invention is preferably a syndiotactic or isotactic propylene-based polymer.

The propylene-based copolymer may contain additives. Examples of such additives include antioxidants, UV absorbers, UV blockers, antistatic agents, lubricants, nucleating agents, anticlouding agents, and antiblocking agents. Examples of the antioxidants include phenolic antioxidants, phosphorus-containing antioxidants, sulfur-containing antioxidants, hindered amine antioxidants (HALS), and composite antioxidants having, for example, a phenolic antioxidant unit and a phosphorus-containing antioxidant unit in one molecule. Examples of the UV absorbers include 2-hydroxybenzophenone-based UV absorbers and hydroxytriazole-based UV absorbers, and examples of the UV blockers include benzoate-based UV blockers. Examples of the antistatic agents include polymer-type, oligomer-type and monomer-type antistatic agents. Examples of the lubricants include higher fatty acid, amides, such as erucamide and oleamide, higher fatty acids, such as stearic acid, and their metal salts. Examples of the nucleating agents include sorbitol-based nucleating agents, organophosphate salt nucleating agents, and macromolecule-type nucleating agents such as polyvinyl cycloalkane. As the antiblocking agents, fine particles having a spherical shape or an approximately spherical shape may be used regardless of whether they are inorganic particles or organic particles. Two or more additives may be used in combination.

The propylene-based copolymer forming the film of the present invention includes crystals containing smectic crystals and the percentage of the smectic crystals to all the crystals of the propylene-based copolymer is 90% or more. While main crystal structures of a propylene-based copolymer are an α crystal form and a smectic crystal form, the film of the present invention is characterized in that the percentage of smectic crystals to all the crystals of the propylene-based copolymer is 90% or more. In the present invention, the percentage of smectic crystals to all the crystals is the percentage of the area of a profile derived from smectic crystals to the area of the whole X-ray diffraction profile measured by wide angle X-ray diffraction. It is desirable that most of the diffraction profile is a profile derived from smectic crystals. Even if α crystals are present, it is desirable that the α crystals are not of spherulite structure.

The diffraction profile derived from α crystals is composed of four sharp peaks appearing at about 14.2°, about 16.7°, about 18.5°, and about 21.4°, respectively, observed in wide angle X-ray diffraction measurement within a diffraction angle (2θ) range of from 10° to 30°. The diffraction profile derived from smectic crystals is composed of two broad peaks appearing at about 14.6° and about 21.2°.

Whether most of the diffraction profile is occupied by the profile derived from smectic crystals or not is judged on the basis of whether the peak that appears within the diffraction angle range of from 13° to 15° is broad or not. When the peak is broad, most of the diffraction profile is occupied by a profile derived from smectic crystals. Specifically, the judgment is carried out as follows. Where in an X-ray diffraction profile the intensity of the peak highest in diffraction intensity within the diffraction angle range of from 13° to 15° is let be C, most of the diffraction profile is judged to be occupied by the profile derived from smectic crystals when the peak width D of the peak at a level of C×0.8 is 1° or more. (See FIG. 2)

The percentage of the area of the profile derived from smectic crystals occupying in the area of the whole wide angle X-ray diffraction profile is calculated as follows:

(1) Whether most of the diffraction profile is occupied by smectic crystals or not is judged by the above-mentioned method.

(2) When most of the diffraction profile is judged to be derived from smectic crystals, the percentage of the profile derived from smectic crystals is calculate by the following procedures.

(3) The diffraction profile is divided into the profile of smectic crystals and the profile of α crystals by peak resolution software.

(4) Within the diffraction angle range of from 10° to 30°, the area of the whole diffraction profile and the area of the diffraction profile derived from smectic crystals are determined, and then the ratio of the latter to the former is calculated.

If the film of the present invention is stretched, the film will become a retardation film that is high in transparency, retardation uniformity, and front contrast. Contrast is a ratio of the brightness exhibited when a liquid crystal display device displays white (white brightness) and the brightness exhibited when the device displays black (black brightness). The front contrast is a value of contrast obtained when the white brightness and the black brightness are measured from the front of the liquid crystal display device. When a retardation film is mounted in a liquid crystal display device, it is required to show a high front contrast.

Moreover, in order to minimize as much as possible optical nonuniformity derived from nonuniformity in thickness or in orientation after stretching, the film of the present invention is an optically uniform, non-oriented or approximately nonoriented film. The in-plane retardation of such a film is 50 nm or less.

One example of the method for producing the film of the present invention is a method that includes melt-kneading a propylene-based copolymer in an extruder and then extruding it through a T-die mounted to the extruder, and hauling up the molten sheet extruded through the T-die while cooling and thereby solidifying it in contact with a chill roll. The following three methods are major examples of a method for cooling a molten sheet extruded through a T-die to solidify by holding the sheet in contact with a roll.

[1] A method that includes nipping a molten sheet extruded through a T-die, between two rolls.

[2] A method that includes nipping a molten sheet extruded through a T-die between a chill roll and a endless metal belt that is arranged in a manner that the belt can be in contact with the chill roll circumferentially along the roll.

[3] A method that includes cooling a molten sheet extruded through a T-die by holding the sheet in contact with a chill roll without nipping the sheet between two rolls.

The method for nipping a molten sheet extruded through a T-die may be a method that includes nipping the sheet with a higher-hardness roll (so-called chill roll) and a lower-hardness roll (so-called touch roll). Examples of the method for cooling a molten sheet extruded through a T-die by holding the sheet in contact with a chill roll without nipping the sheet between two rolls includes a method that comprises cooling the sheet with a chill roll and an air chamber and a method that comprises cooling the sheet with a chill roll and electrostatic pinning.

The film of the present invention in which the percentage of smectic crystals to all the crystals of the propylene-based copolymer is 90% or more can be produced by, for example, using a propylene-based copolymer and adjusting the surface temperature of the chill roll at 20° C. or lower. For example, in the case of using a method that includes nipping a molten resin extruded through a T-die between two rolls, the surface temperature of at least one roll may be adjusted to 20° C. or lower. Moreover, a method that includes nipping a molten sheet with a chill roll and a touch roll and a method that includes nipping a molten sheet between a chill roll and an endless metal belt that is arranged in a manner that the belt can be in contact with the chill roll along the circumferential direction of the roll are preferred as being advantageous for reducing the percentage of α crystals to all the crystals. In order that when cooling and solidify a molten resin it is possible to cool the whole molten resin rapidly, it is desirable that the thickness of the film be 30 to 200 μm.

In order to make a resulting film have an in-plane retardation of 50 nm or less, it is necessary to prevent a bank (i.e., a puddle of resin) from being formed during the step of cooling and solidifying a molten sheet extruded through a T-die. The bank is formed when the nipping force is too high when nipping a molten sheet between a chill roll and a touch roll or between a chill roll and an endless metal belt. In order to prevent the formation of a bank, it is desirable to adjust the nipping force to 20 N/mm or less, more desirably 10 N/mm or less. A method of cooling a molten sheet extruded through a T-die by using a chill roll and an air chamber and a method of cooling a molten sheet by using a chill roll and electrostatic pinning do not result in the formation of a bank and therefore they are advantageous for reducing the in-plane retardation. In order to nip a molten sheet at a low pressure, a rubber roll is preferable as the touch roll used in the method of nipping the molten sheet with a chill roll and a touch roll. As the endless metal belt used in the method of nipping the molten sheet with a chill roll and an endless metal belt is preferred an endless metal belt that can be elastically deformed. In more detail preferred is a structure in which there are an outer cylinder made of an elastically deformable endless metal belt and an elastically deformable roll made of an elastic material that is disposed inside the outer cylinder and the space defined between the outer cylinder and the elastic material roll is filled with a medium for temperature control.

When using a rubber roll as the touch roll, in order to form a retardation film having a mirror surface, it is preferable to superpose a molten material extruded through a T-die on a support and nip them together between the chill roll and the rubber roll. A biaxially drawn film having a thickness of from 5 to 50 μm made of a thermoplastic resin is preferred as the support.

When a film is formed by a method including nipping a molten sheet between a chill roll and an endless metal belt, it is desirable that the endless belt be held with two or more rolls that are arranged parallel to the rotation axis of the chill roll along the circumferential direction of the chill roll. It is more desirable that the endless belt be supported by two rolls each having a diameter of from 100 to 300 mm and that the endless belt be from 100 to 500 μm in thickness.

In order to obtain a retardation film better in optical uniformity, it is desirable that the film to be used for the production of the retardation film (so-called precursor film) be small in thickness unevenness, and it is more desirable that the difference between the maximum value and the minimum value of the thickness of the film be 10 μm or less, and it is even more desirable that the difference be 4 μm or less.

A retardation film can be obtained by stretching the film of the present invention. Examples of the method of the stretching include longitudinal stretching, transverse stretching, sequential biaxial stretching, and simultaneous biaxial stretching. The method of the stretching for the preparation of a retardation film varies depending upon the type of the liquid crystal display device into which the retardation film is incorporated, and it may be only longitudinal stretching, or only transverse stretching, or biaxial stretching. When a retardation film is used for a vertical alignment mode liquid crystal display, the retardation film is produced by biaxial stretching. With regard to sequential biaxial stretching, it may be performed by either of a method in which longitudinal stretching is followed by transverse stretching and a method in which transverse stretching is followed by longitudinal stretching.

Examples of the method of the longitudinal stretching include a method of stretching a precursor film using the rotation rate difference between two or more rolls and a long-span stretching method. The long-span stretching method is a method using a longitudinal stretching machine having two pairs of nip rolls and an oven positioned therebetween in which a precursor film is stretched on the basis of the rotation rate difference between the two pairs of nip rolls while being heated in the oven. In order to obtain a retardation film with high optical uniformity, the long-span longitudinal stretching method is preferred. In particular, it is preferable to use an air floating oven and perform long-span longitudinal stretching in the oven. The air floating oven is an oven having such a structure that when a precursor film is introduced into the oven, hot air can be blown to both sides of the precursor film from upper nozzles and lower nozzles, wherein the upper nozzles and the lower nozzles are disposed alternately along the conveyance direction of the film. In the oven, the precursor film is stretched so as not to come into contact with the upper nozzles or the lower nozzles. The stretching temperature to be used in this case is not lower than 90° C. and not higher than the melting point of the propylene-based copolymer. In the event that the oven is divided into two or more zones, the temperatures of the zones may be either the same or different.

While the longitudinal stretching ratio is usually from 1.01 to 5, and it is preferably from 1.05 to 3 because a retardation film having a higher optical uniformity can be obtained.

The method of transverse stretching may be a tenter method. The tenter method is a method in which a film whose both edges in the film width direction are fixed with chucks is stretched through the elongation of the chuck interval in an oven. In the tenter method, a machine is used in which the oven temperatures of a zone where a preheating step is performed, a zone where a stretching step is performed and a zone where a heat setting step is performed can be controlled independently. While the transverse stretching ratio is usually from 2 to 10, and it is preferably from 4 to 7 in order to obtain a retardation film having a higher optical uniformity.

The preheating step in the transverse stretching is a step provided before the step of stretching a film in the transverse direction and it is a step of heating a film to a temperature high enough for stretching the film. The preheating temperature in the preheating step means the temperature of the atmosphere in a zone of the oven in which zone the preheating step is performed. The preheating temperature may be not lower than the melting point of the propylene-based copolymer of the film to be stretched and also may be not higher than the melting point. Usually, in order to obtain an improved uniformity in the retardation of a retardation film, the preheating temperature is set preferably within the range of from a temperature 10° C. lower than the melting point of the propylene-based copolymer to a temperature 10° C. higher than the melting point of the propylene-based copolymer, and it is set more preferably within the range of from a temperature 5° C. lower than the melting point of the propylene-based copolymer to a temperature 5° C. higher than the melting point of the propylene-based copolymer.

The stretching step in the transverse stretching is a step of stretching a film in the transverse direction. The stretching temperature in this stretching step, which temperature means the temperature of the atmosphere in the zone where the stretching step is performed in an oven, may be any of a temperature lower than the preheating temperature, a temperature higher than the preheating temperature, and a temperature equal to the preheating temperature. Usually, by stretching the preheated film at a temperature lower than the preheating step, it becomes possible to stretch the film uniformly and, as a result, a retardation film excellent in uniformity of optical axis and retardation can be obtained. Therefore, the stretching temperature is preferably 5 to 20° C. lower, and more preferably 7 to 15° C. lower than the preheating temperature in the preheating step.

The heat-setting step in the transverse stretching is a step of passing a film through an atmosphere at a predetermined temperature in an oven while maintaining the film at a width which the film had at the completion of the stretching step. The heat-setting temperature may be any of a temperature lower than the stretching temperature in the stretching step, a temperature higher than the stretching temperature, and a temperature equal to the stretching temperature. Usually, in order to effectively improve the stability of optical characteristics of a film, such as retardation and optical axis, the heat-setting temperature is preferably within the range of from a temperature 10° C. lower than the stretching temperature in the stretching step to a temperature 30° C. higher than the stretching step.

The method of transverse stretching may further have a heat relaxation step. In a tenter method, this step usually is performed in a heat relaxation zone that is provided between the stretching zone and the heat setting zone, the temperature of the heat relaxation zone being controllable independently from other zones, or the step is performed in the zone where the heat setting step is performed. Specifically, the heat relaxation is performed by stretching a film to a predetermined width in the stretching step and then narrowing chuck intervals by several percent (usually, 0.1 to 10%) to remove needless distortion.

While the retardation which a retardation film is required to have varies depending upon the kind of a liquid crystal display device into which the retardation film is incorporated, the in-plane retardation R₀ normally is from 30 to 150 nm. When a retardation film is used in a vertical alignment mode liquid crystal display, it is preferable, from the viewpoint of being excellent in viewing angle characteristics, that the in-plane retardation R₀ be from 40 to 70 nm and that the thickness direction retardation Rₜₕ, be from 90 to 230 nm. The thickness of the retardation film is usually from 10 to 100 μm. In order to reduce the thickness of a liquid crystal display device, it is desirable that a retardation film be as thin as possible, and the thickness of the retardation film is preferably 10 to 50 μm. By controlling the stretching ratio in the production of a retardation film and the thickness of a precursor film, a retardation film having a desired retardation and a desired thickness can be obtained.

In order to form a retardation film that is high in retardation uniformity, it is necessary to perform the stretching of a precursor film in a state that the percentage of smectic crystals of the precursor film is 90% or more. Even if the percentage of smectic crystals just after the production of a precursor film is 90% or higher, the percentage of smectic crystals may decrease to become less than 90%. Therefore, it is preferable to perform the stretching within 168 hours, more preferably within 72 hours, of producing a precursor film. Moreover, a method in which stretching is performed without winding a produced precursor film is preferred in order to perform stretching while the percentage of smectic crystals is maintained high. In order to maintain a state that the percentage of smectic crystals of a precursor film is 90% or more, it is desirable to store the precursor film at a temperature which is as low as possible during a period from the production of the precursor film through the stretch of the precursor film. Specifically, the storage temperature of a precursor film is preferably 30° C. or lower, more preferably 20° C. or lower, and particularly preferably 10° C. or lower. Although the lower limit of the storage temperature of a precursor film is not restricted, the storage temperature is usually not lower than −10° C.

The retardation film of the present invention is used suitably in the form of a liquid crystal display device, such as a cellular phone, a personal computer, and a large-sized television, after being laminated with a polarizer, a liquid crystal layer, and so on. A retardation film produced from the film of the present invention has an internal haze of 0.5% or less and therefore is very high in transparency. Hence, a liquid crystal display device using the retardation film of the present invention becomes high in front contrast. Haze is an index that indicates the transparency of a film. The smaller the haze, the more transparent the film. The haze is a physical property value that can be measured in accordance with JIS K-7136. The transparency of a film is influenced by scatter due to the surface state of the film and scatter due to the internal state of the film, and therefore the greater the degree of each scatter is, the more the transparency of a film decreases. The transparency that decreases from the influence of the scatter due to the surface state of a film does not reduce the front contrast of a liquid crystal display device in which the retardation film of the present invention is used. Therefore, in order to correctly evaluate the performance of a retardation film of the present invention, it has been decided to evaluate a value resulting from elimination of the transparency having decreased because of the influence of scatter due to the surface state of the film. In the present invention, this index is called internal haze. The internal haze is a value that is measured by a method in accordance with JIS K-7136 in such a state that a film to be measured is placed in a quartz glass vessel (cell) together with dimethyl phthalate, which is a liquid having a refractive index almost equal to that of a polypropylene resin.

### EXAMPLES

The present invention is described with reference to examples, but the invention is not limited to the examples.

### (1) Preliminary Test

From a film made of a polypropylene resin is taken a sample that is 70 mm long in the longitudinal direction of the film and 60 mm in the transverse direction of the film. The MD of this film is the longitudinal direction, and the direction perpendicular to the longitudinal direction on the film plane is the lateral direction. In accordance with JIS K-7163, a tensile testing machine equipped with a thermostatic oven is used. The sample is held with chucks at its both longitudinal ends so that the distance between the chucks will become 30 mm. Then, the sample is stretched in the longitudinal direction of the film, at a temperature at which the stress at a strain of 200% becomes 0.8±0.1 MPa, at a tensile rate of 100 mm/min until the strain becomes 600%. In the stress-strain curve (S-S curve) obtained by this method, parameter (A) is calculated from Formula (1):

Parameter (A)=(B₆₀₀−B₂₀₀)/400 Formula (1)

wherein B₆₀₀ and B₂₀₀ represent a stress (MPa) at a strain of 600% and a stress (MPa) at a strain of 200%, respectively.

### (2) Evaluation of Uniformity of Stretched Film

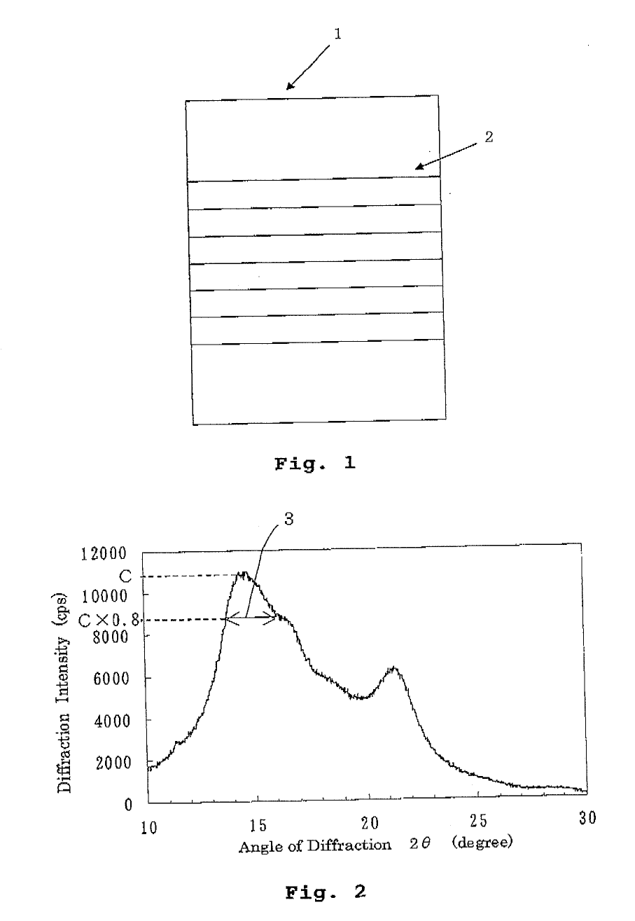

In a tensile test that is done in the same procedures as the preliminary test described above, seven straight lines parallel to the lateral direction of the film were drawn before stretching, at intervals of 5 mm, on a portion of the film located between the chucks (see FIG. 1), and the distances between the parallel lines were measured after stretching, and the standard deviation of the six distances was used as an index of the uniformity of the stretched film. The value of this standard deviation was well in conformity with the uniformity of retardation.

### (3) Melting Point

To apiece (10 mg) of a film made of a polypropylene resin were applied the following heat histories [1] through [5] under a nitrogen atmosphere using a differential scanning calorimeter (DSC-7, manufactured by PerkinElmer, Inc.), followed by heating from 50° C. to 180° C. at a rate of 5° C./min. Thus, a melting curve was produced. In the melting curve, the temperature (° C.) at which the highest endothermic peak appeared was determined and this temperature was defined as the melting point (Tm) of the propylene-based polymer.

[1] Heating at 220° C. for 5 minutes.
[2] Cooling from 220° C. to 150° C. at a rate of 300° C./min.

### [3] Keeping at 150° C. for 1 min.

[4] Cooling from 150° C. to 50° C. at a rate of 5° C./min

### [5] Keeping at 50° C. for 1 min.

### (4) Melt Flow Rate (MFR)

The melt flow rate was measured at a temperature of 230° C. and a load of 21.18 N in accordance with JIS K7210.

### (5) Ethylene Content, Butene Content

For a propylene-based copolymer, the content of constitutional units derived from ethylene in the copolymer was determined by performing IR spectrum measurement disclosed in “Macromolecule Analysis Handbook” (published by Kinokuniya Co., Ltd., 1995), page 616. Similarly, the content of constitutional units derived from butene in the propylene-based copolymer was determined by performing IR spectrum measurement disclosed in “Macromolecule Analysis Handbook” (published by Kinokuniya Co., Ltd., 1995), page 619.

### (6) Wide Angle X-Ray Diffraction

Measurement was done within the diffraction angle (2θ) range of 10° to 30°. The resulting diffraction profile was analyzed in the following procedures.

First, whether most of the diffraction profile is derived from smectic crystals or not is judged. Specifically, where in a diffraction profile the intensity of the peak highest in diffraction intensity within the diffraction angle range of from 13° to 15° is let be C, most of the diffraction profile is judged to be occupied by the profile derived from smectic crystals when the peak width D of the peak at a level of C×0.8 is 1° or more.

The percentage of the area of the profile derived from smectic crystals occupying in the area of the whole wide angle X-ray diffraction profile is calculated as follows:

\textcircled{1} Whether most of the diffraction profile is occupied by smectic crystals or not is judged by the above-mentioned method.
\textcircled{2} When most of the diffraction profile is judged to derive from smectic crystals, the percentage of the profile derived from smectic crystals is calculate by the following procedures.
\textcircled{3} The diffraction profile is divided into the profile of smectic crystals and the profile of α crystals by peak resolution software. As analysis software was used JADE (Ver. 5) software produced by Rigaku Corporation. On the basis of the peak resolution command attached to the software, a profile property necessary for the peak resolution of the diffraction profile is let be Pearson-Vl1=1.5.
\textcircled{4} For increasing precision, the angles of diffraction used for peak resolution in examples and comparative examples were 14.6° and 21.2° derived from smectic crystals and 14.2°, 16.7°, 18.5°, and 21.4° derived from α crystals, and these were fixed values.
\textcircled{5} Moreover, optimization was performed by selecting a height a half value width, a meter constant, and asymmetry as variables for increasing precision. As a result, the area of a diffraction profile having peaks at 14.6° and 21.2° derived from smectic crystals was calculated, and then the percentage of the area of the profile derived from smectic crystals was determined by dividing this area by the overall area of the diffraction profile.

### (7) In-Plane Retardation R₀ and Thickness Direction Retardation Rₜₕ

In-plane retardation R₀ and thickness direction retardation Rₜₕ were measured by using a retardation analyzer (KOBRA-WPR manufactured by Oji Scientific Instruments).

### (8) Internal Haze

The internal haze was measured by a method in accordance with JIS K-7136 in such a state that a film to be measured was placed in a quartz glass vessel (cell) together with dimethyl phthalate, which was a liquid having a refractive index almost equal to that of a polypropylene resin.

### (9) Front Contrast

Front contrast was measured in the following procedures by preparing a retardation film, laminating it to a polarizer, and installing the laminate into a liquid crystal display device (liquid crystal television “BRAVIA KDL-32S1000” manufactured by Sony Corp.). The larger the value of front contrast, the more clearly the color of the image displayed on the liquid crystal display device looks.

### (A) Preparation of Retardation Film

A biaxial retardation film having an in-plane retardation of about 60 nm and a thickness direction retardation of about 110 nm was obtained by sequentially stretching a precursor film at a longitudinal stretching ratio of about 2 and a transverse stretching ratio of about 4. Subsequently, corona discharge treatment was applied to a surface of this retardation film.

### (B) Preparation of Composite Polarizing Plate

A polarizer made of a polyvinyl alcohol film with iodine adsorbed and oriented thereon was prepared. The corona discharged surface of the aforementioned retardation film was joined onto one side of the polarizer and a triacetylcellulose film with a surface having been saponified was joined onto the other side of the polarizer each with an adhesive that was an aqueous solution of a water-soluble polyamide epoxy resin (SUMIREZ RESIN 650 produced by Sumitomo Chemical Co., Ltd.) and polyvinyl alcohol. Then, the resultant was dried at 80° C. for 5 minutes and subsequently was aged at 40° C. for about 72 hours. Thus, a composite polarizing plate was prepared.

### (C) Evaluation of Composite Polarizing Plate

A liquid crystal television “BRAVIA KDL-32S1000” manufactured by Sony Corp. was disassembled, and the polarizing plates laminated on each side of a liquid crystal cell were removed. Instead of the polarizing plates that had been installed in a product, the composite polarizing plate obtained above was laminated on its retardation film side onto each side of the liquid crystal cell with a pressure-sensitive adhesive. After reassembling of a television, a backlight was turn on and front contrast was measured with a liquid crystal viewing angle analyzer “EZ Contrast 160R” manufactured by ELDIM.

### Example 1

A propylene-ethylene random copolymer (MFR=8 g/10 minutes, ethylene content=4.6% by weight) was charged into a 50 mmφ extruder the cylinder temperature of which was adjusted to 250° C. The copolymer was then melt-kneaded there, followed by extrusion through a 450 mm-wide T-die attached to the extruder at an extrusion rate of 13 kg/h. The extruded molten sheet was pressed to cool between a 250 mmφ chill roll adjusted to 13° C. and a touch roll composed of a metal sleeve (an outer tube) adjusted to 13° C. and an elastic roll arranged inside the metal sleeve. Thus, a 100 μm thick film was obtained. The press line pressure applied during this operation was 5 N/mm and no bank was generated in between the chill roll and the touch roll. The distance (air gap) defined between the discharge opening of the T-die and the rolls was 20 mm and the distance over which the molten sheet was pressed in between the chill roll and the touch roll was 10 mm. From the thus obtained film were taken samples to be used for various evaluations. The samples had a melting point of 136° C. and an in-plane retardation of 30 nm. In the diffraction profile obtained by the wide angle X-ray diffraction measurement, the peak highest in diffraction intensity within the diffraction angle range of from 13° to 15° had an intensity C of 10900 cps and a peak width D at a level C×0.8 of 2.5°. On the basis of this result, it was judged that most of the diffraction profile of this sample was a profile derived from smectic crystals. The percentage of the area of the profile derived from smectic crystals in the area of the whole wide angle X-ray diffraction profile was 96%. Moreover, no spherulite was generated in this sample.

In accordance with the procedure of “(1) Preliminary test” described above, a sample was longitudinally stretched at a stretching temperature of 140° C. until the strain became 600%. The stress B₂₀₀ at a strain of 200% was 0.77 MPa, the stress B₆₀₀ at a strain of 600% was 1.19 MPa, and the parameter (A) determined from Formula (1) was 0.0011.

In accordance with the procedure of “(2) Evaluation of uniformity of stretched film” described above, a standard deviation of the distances between the lines drawn on a film was determined to be 1.5 after stretching and it was found that the retardation unevenness was small.

A stretched film having a thickness of 15 μm, an in-plane retardation of 50 nm and a thickness direction retardation of 110 nm was obtained by storing the above-mentioned film at 23° C. for 20 hours after the completion of the production thereof, stretching the film (precursor film) in a longitudinal direction at a ratio of 2 with a long-span longitudinal stretching machine using an air floating oven, and then stretching the film transversely at a ratio of 4 with a tenter transverse stretching machine. In the whole area of the X-ray diffraction profile of the precursor film, the percentage of the area of the profile derived from smectic crystals was 4% even 20 hours after the completion of the production of the precursor film and no spherulite generated. The internal haze of the resulting stretched film was 0.1%. When the stretched film was installed in a liquid crystal display device and front contrast was measured, it was found that the front contrast was 1500.

### Example 2

A propylene-ethylene random copolymer (MFR=1.5 g/10 minutes, ethylene content=5.7% by weight) was charged into a 65 mmφ extruder the cylinder temperature of which was adjusted to 240° C. The copolymer was then melt-kneaded there, followed by extrusion through a 1200 mm-wide T die attached to the extruder at an extrusion rate of 46 kg/h. The extruded molten sheet was pressed to cool between a 400 mmφ chill roll adjusted to 13° C. and a touch roll composed of a metal sleeve (an outer tube) adjusted to 13° C. and an elastic roll arranged inside the metal sleeve. Thus, a 200 μm thick film was obtained. The air gap was 150 min and the distance over which the molten sheet was pressed in between the chill roll and the touch roll was 20 mm. From the thus obtained film were taken samples to be used for various evaluations. A sample had a melting point of 129° C. and an in-plane retardation of 25 nm. The percentage of the area of the profile derived from smectic crystals in the area of the whole wide angle X-ray diffraction profile of a sample was 96%.

In accordance with the procedure of “(1) Preliminary test” described above, a sample was longitudinally stretched at a stretching temperature of 130° C. until the strain became 600%. In Table 1 are given B₂₀₀, B₆₀₀ parameter (A), and the uniformity of a stretched film. The retardation unevenness of the stretched film was small.

### Comparative Example 1

A film was prepared in the same manner as Example 1 except for changing the temperatures of the chill roll and the touch roll to 30° C., and then a preliminary test was performed. In the diffraction profile obtained by the wide angle X-ray diffraction measurement of this film, the peak highest in diffraction intensity within the diffraction angle range of from 13° to 15° had an intensity C of 5400 cps and a peak width D at a level C×0.8 of 0.6°. On the basis of this result, it was judged that in the X-ray diffraction profile of this sample, the profile derived from smectic crystals was clearly less than 90% of the whole area of the diffraction profile. Moreover, spherulites were generated in this film. This film had an in-plane retardation of 30 nm.

A stretched film having an in-plane retardation of 50 nm and a thickness direction retardation of 110 nm was obtained by using the above-mentioned film as a precursor film, stretching the film in a longitudinal direction at a ratio of 1.5 with a long-span longitudinal stretching machine using an air floating oven, and then stretching the film transversely at a ratio of 3.5 with a tenter transverse stretching machine. When the stretched film was installed in a liquid crystal display device and front contrast was measured, it was found that the front contrast was 300.

### Comparative Example 2

Samples were prepared in the same manner as Example 1 except for changing the material of a film to a propylene-ethylene random copolymer (MFR=2 g/10 min, ethylene content=0.5% by weight), and evaluations of uniformity of a stretched film, and so on were performed. A film before stretching had an in-plane retardation of 35 nm.

TABLE 1

| | | | Comparative | Comparative |
|---|---|---|---|---|
| | Example 1 | Example 2 | Example 1 | Example 2 |
| Percentage of | 96 | 96 | Less than 90 | 97 |
| smectic crystals | | | | |
| (%) | | | | |
| Tm (° C.) | 136 | 129 | 136 | 159 |
| Stretching | 140 | 130 | 140 | 164 |
| temperature | | | | |
| (° C.) | | | | |
| B₂₀₀ (MPa) | 0.77 | 0.85 | 0.72 | 0.80 |
| B₆₀₀ (MPa) | 1.19 | 1.21 | 1.07 | 1.03 |
| Parameter (A) | 0.0011 | 0.0009 | 0.0009 | 0.0006 |
| Peak intensity | 10200 | 11300 | 5400 | 13400 |
| C (cps) | | | | |
| Peak width D | 2.5 | 3.8 | 0.6 | 2.1 |
| (degree) | | | | |
| Uniformity of | 1.5 | 1.7 | 1.8 | 9.4 |
| stretched film | | | | |
| (standard | | | | |
| deviation) | | | | |
| Front contrast | 1500 | —*1) | 300 | —*1) |
| Internal haze | 0.1 | —*1) | 8.5 | —*1) |
| (%) | | | | |

*1)“—” means that measurement was not performed.

### INDUSTRIAL APPLICABILITY

The film of the present invention is useful as a precursor film to be subjected to stretching in the production of a retardation film. A retardation film obtained by stretching of this film is useful as a constituent element of a liquid crystal display device because the retardation film is high in transparency, so that it can develop a high front contrast when being installed in a liquid crystal display device.

1. A film comprising a propylene-based copolymer selected from among propylene-based random copolymers and propylene-based block copolymers,
wherein the propylene-based copolymer forming the film comprises crystals containing smectic crystals and the percentage of the smectic crystals to all the crystals of the propylene-based copolymer is 90% or more,
wherein the film has an in-plane retardation of 50 nm or less and a thickness falling within the range of from 30 to 200 μm, and the propylene-based copolymer is a polymer that has a parameter (A) falling within the range of from 0.0007 to 0.1, the parameter (A) being calculated from Formula (1) defined for stress-strain curve produced as a result of stretching a film made of the polymer at a tensile rate of 100 mm/minute at a temperature at which a stress of 0.8±0.1 MPa is produced at a strain of 200%:
(A)=(B₆₀₀−B₂₀₀)/400 Formula (1)
wherein B₆₀₀ and B₂₀₀ represent a stress (MPa) at a strain of 600% and a stress (MPa) at a strain of 200%, respectively.

2. A retardation film obtained by stretching the film of claim 1.

3. The retardation film of claim 2, wherein the retardation film has an internal haze of 0.5% or less, a thickness of from 10 to 50 μm, and an in-plane retardation of from 30 to 150 nm.

4. A liquid crystal display device comprising the retardation film of claim 2.

5. A liquid crystal display device comprising the retardation film of claim 3.
